(19) United States
(12) Patent Application Publication
(10) Pub. No.: US 2010/0082391 A1
(43) Pub. Date: Apr. 1, 2010

(54) METHOD, DEVICE, AND SYSTEM FOR APPOINTMENT MESSAGING

(76) Inventors: Ebbe Bruun SOERENSEN, Copenhagen (DK); Bo Nielsen, Stenloese (DK)

Correspondence Address: Pearl Cohen Zedek Latzer, LLP, 1500 Broadway, 12th Floor, New York, NY, 10036, US

(21) Appl. No.: 12/238,615

(22) Filed: Sep. 26, 2008

(51) Int. Cl. G05B 19/00; G06Q 10/00

(52) U.S. Cl. 705/8

(57) ABSTRACT

Appointment information for a user may be entered at a computer. A first signal may be sent from the computer, via a network, to a server remote from the computer, the content of the first signal including for example data related to the appointment information. Sending the first signal may be triggered by completion of the entering appointment information for the user. The content of the first signal may be processed at the server according to the appointment information, and a message may be sent from the server to the user relating to the appointment. A response to the message may be received from the user.

### FIELD OF THE INVENTION

The present invention relates to methods and systems for communicating with clients having scheduled appointments and with office personnel for managing these appointments.

### BACKGROUND OF THE INVENTION

In numerous service industries, professionals operate by scheduling appointments in advance to meet with clients. For example, in the medical industry, a doctor or dentist will arrange to meet with a patient by scheduling an appointment with the patient in advance of the appointment for example by telephone or in person when completing a current appointment. Without any further contact, some of these scheduled appointments may be missed for various reasons, such as for example, a client forgetting the appointment or having a conflicting engagement arise. To reduce the occurrence of missed appointments, the office staff of the professional may contact the client in advance to confirm the existence of an appointment. With the advent of modern computing, the management and tracking of these appointments may be accomplished with software loaded on an office computing platform such as for example DentalVision®, Dentrix®, and EasyDental® from Henry Schein Practice Solutions, MacPractice® from MacPractice, Inc., and Patterson EagleSoft® from Patterson Dental Supply.

Such appointment management software may be capable additionally of notifying office personnel to remind clients of upcoming appointments to increase the likelihood of clients appearing for their scheduled appointments. Office personnel may then use telephone, e-mail or other appropriate technology to contact clients to remind them about scheduled appointments. Alternatively, the management of messages to clients can be uncoupled from appointment management. Furthermore, with the success of the Internet and other public networks as mediums for business and personal communications, management of client messaging can be performed as an automated service remotely from the office scheduling the appointments. Such client messaging managers may be capable of storing appointment information for an office and contacting clients to remind them of upcoming appointments.

In some prior art systems, appointment management software at an office may transmit data for one or more appointments to the remote client messaging manager on a regular basis. The client messaging manager may in turn process and store the data in order to contact one or more clients regarding upcoming appointments.

However, the reliability of such systems may be compromised if the client has rescheduled or cancelled an appointment. For example, in some circumstances the client messaging manager may still send a reminder regarding the original appointment. Other problems may arise if the client messaging manager is unable to deliver the reminder to the client.

### DESCRIPTION OF THE DRAWINGS

Specific embodiments of the present invention will be described with reference to the following drawings, wherein:

FIG. 1 is a simplified block diagram of a system for appointment messaging in accordance with an embodiment of the invention.

FIG. 2 is a simplified software block diagram of components for appointment messaging in accordance with an embodiment of the invention.

FIG. 3 is a flowchart showing a method for appointment messaging in accordance with an embodiment of the invention.

FIG. 4 is a table showing a format for sending appointment information to a server in accordance with an embodiment of the invention.

FIG. 5 is a table showing a format for a text or short messaging service (SMS) template to send to a client device in accordance with an embodiment of the invention.

FIG. 6 is a flowchart showing a method for appointment messaging in accordance with an embodiment of the invention.

FIG. 7 is a flowchart showing a method for requesting a status update in accordance with an embodiment of the invention.

FIG. 8 is a table showing a format for a status request message in accordance with an embodiment of the invention.

FIG. 9 is a table showing a format for a server to respond to a status request in accordance with an embodiment of the invention.

FIG. 10 is a flowchart showing a method for cost determination in accordance with an embodiment of the invention.

### SUMMARY

Embodiments of the present invention may include methods and systems for sending messages to a user having an appointment. In one embodiment, information may be entered at a computer and a first signal sent to a server remote from the computer, the content of the first signal including at least data related to the appointment information. Sending the first signal may be triggered for example by completion of the entering appointment information for the user. The content of the first signal may be processed at the server according to the appointment information. The server may send a message to the user relating to the appointment and may receive a response to the message from the user

In another embodiment, a server may receive, via for example a network, from a computer remote from the server, a first signal including information regarding an appointment for a user. The server may send a message, to a client device of the user, including instructions for responding to the message. The server may receive a response to the message from the client device of the user and may send information regarding the response to the computer.

In another embodiment, a system may include a server for receiving a first signal sent from a computer remote from the server, via a network, the content of the first signal comprising data related to appointment information for a user having an appointment, and the appointment information entered at the computer remote from the server. Sending the first signal may be triggered for example by completion of the entering appointment information for the user at the computer for entering appointment information for a user having an appointment. The server may be configured for processing the content of the first signal according to the appointment information, for sending a message to the user relating to the appointment, and for receiving from the user a response to the message.

In another embodiment, a system may include a server for receiving a first signal sent from a computer remote from the server, via a network. The content of the first signal may include data related to appointment information for a user having an appointment, and the appointment information may be entered at the computer remote from the server. The server may be configured for sending to a client device of the user a message, the message including instructions for responding to the message; for receiving from the client device, a response to the message; and for sending information regarding the response to the computer remote from the server.

In another embodiment, a server may receive from a computer, a signal including information relating to an appointment of a user. The server may send to a client device of the user a message relating to the appointment of the user and may send to the computer a status of the appointment for the user. The status may be dependent on whether an acknowledgement that the message was received from the client device of the user. If the acknowledgement for the message was not received, the status of the appointment may be an error signal.

In another embodiment, a data package may be received from a computer operated by an organization, the data package including information relating to an appointment of a user. A message and signal type may be sent to a message distributor. The message may relate to the appointment of the user and may include instructions for responding to the message. The message distributor may send a signal including the message according to the signal type. A bill for expenses relating to the sending of the message according to a set of parameters of the signal may be sent to the organization operating the computer.

In another embodiment, a server may receive from a computer a data package including information relating to an appointment of a user. The computer may be operated by an organization. The server may send a message and a signal type to a message distributor. The message may relate to the appointment of the user and include instructions for responding to the message. The server may send a signal including the message from the message distributor according to the signal type; and for sending a bill to the organization operating the computer for expenses relating to the sending of the message according to a set of parameters of the signal.

In another embodiment, a server may receive from a computer operated by an organization a data package including information relating to an appointment of a user. The server may send a message relating to the appointment of the user and a signal type. The message may include instructions for responding to the message. A message distributor may receive the message and signal type and may send a signal including the message according to the signal type. A billing system may send to the organization operating the computer a bill for expenses relating to the sending of the message according to a set of parameters of the signal.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

As used herein, messages related to an appointment may include, for example, messages intended for a user having the appointment such as for example a reminder of the appointment or instructions related to the appointment. These reminders may be sent at any time prior to an appointment including the day of the appointment up to the time of the appointment. Messages related to an appointment may also include status messages, such as for example, messages to a computer or an office worker regarding whether or not messages to the user have been sent or received, whether or not the user has confirmed or acknowledged the existence of an appointment or wishes to cancel the appointment, and similar messages that update or inform a computer or office worker.

As used herein, messages sent as text messages may be or include electronic messages sent over a network such as for example a cellular telephone network using for example short messaging service (SMS) or other communications protocol that allows for short messages of a limited number of characters and spaces, e.g. text-based messages to be sent to mobile telecommunications devices such as for example cellular telephones. The sending of such text messages may be readily automated as known and as employed in the present invention.

Embodiments of the present invention include a system and method for transmitting messages related to an appointment of a user between a server for sending messages and a computer for managing appointments, e.g. an appointment manager, and between the server and a client device of a user having an appointment. The transmissions may be dynamic and allow for immediate action such as for example changes to the appointment or to contact clients. As opposed to prior systems which may restrict the appointment manager to a fixed schedule for updating the server, or bulk updates of data, some embodiments of the present invention may allow for the server to respond immediately to changes in an appointment. Embodiments of the present invention also include a system and method for a user to respond to a message sent to a client device and for relaying the response to the appointment manager. Embodiments of the present invention may also send an error signal to the appointment manager or directly to an office worker if, for example, a message was not delivered to a user, or no confirmation of an appointment was sent by a user. Still other embodiments of the present invention may also send all messages to the client device of a user through a single message distributor to allow for consolidated tracking of expenses related to sending messages to the client device or devices for billing purposes

Embodiments of the present invention may be used for sending and receiving messages regarding appointments to and from clients or users of professional offices (such as for example doctors' patients) or other organizations. Embodiments of the invention may be used by organizations such as government offices, law firms, doctor's offices, clinics, repair facilities, and other such offices and organizations having scheduled appointments with users and/or clients. When a user makes an appointment with the office, information regarding the appointment such as for example date and time and regarding the user such as user profile including preferred contact information may be entered on a computer in the office controlled by the organization. In one embodiment, this information may be sent as soon as or shortly after each appointment entry is created, and as an individual record, rather than as one record in a package or list of entries, sent periodically such as once a day. In such an embodiment, a remote appointment messenger system may be able to send messages to users regarding appointments more quickly and accurately, and receive feedback from the users regarding these appointments than for example a receptionist in a doctor's office whose timeliness in contacting users regarding upcoming appointments is subject to the workload of the office and other potentially detrimental factors.

Once the entry is completed, the information may be sent over a network such as for example the Internet to a server that hosts or executes an appointment messenger which may be for example a software application running on the server. The appointment manager may process and store the information regarding the appointment, and send a message to the client or user regarding the appointment via a client device of the user such as for example a cellular telephone or personal computer (e.g., via an e-mail address).

In some embodiments, any or all messages to users from the server may be sent from or through a single message distributor. Centralizing the message distribution may allow for easy tracking of costs incurred for the transmission and receipt of messages to and from users. The parameters of each message such as for example signal type (e.g., text message, wireline telephone call, etc.), message length, identifier or address of the device being contacted which may be referred to herein for example as a destinator such as telephone number, and identifier for the office sending the message may all be recorded at a single location. These parameters may then be used to generate and send a bill to the office or organization using the appointment messaging service. In other embodiments an actual bill may not be sent—e.g., an account may be debited or credited, or a record of charges may be kept.

The messages to users may include for example a reminder to the user of the appointment, instructions related to the appointment, a confirmation that an appointment has been made. For example, the message may be “Mr. X, you have an appointment with Dr. Y on May 23, 2008 at 8:00 AM.” In some embodiments, the message may also include instructions to the user for how to respond to the message. The response from the user may be for example a confirmation that the user will be able to make the appointment, an acknowledgement that the message was received, or a cancellation of the appointment. For example, the message may include “Please confirm this appointment by pressing ‘1’ or saying ‘yes’ on your touch-tone telephone. If you would like to cancel this appointment, please press ‘2’ or ‘say’ ‘no’.” The user may react accordingly.

Responses from the user may be sent from the same device on which the message to the user was received or on a different device of the user. For example, a message may be left on a user's voicemail in an office. The user may receive the message and respond from his cellular telephone. Responses may be sent either to the message distributor that sent the message to the user or directly to the (e.g., doctor's) office or organization where the appointment was scheduled. The appointment messenger may then be updated according to the response. For example, if a patient calls a doctor's office to change an appointment, a staff member at the doctor's office may update the information on the computer in the doctor's office which may forward the information to the appointment messenger. Sending this information to the appointment messenger when it is entered, rather than as a once-daily bulk upload, may avoid sending erroneous messages to patients for appointments that have either been cancelled or changed. Furthermore, by automatically enabling a user to respond and forwarding the response to the office, the present invention may avoid costly empty appointment times due to cancellations and other causes.

In some embodiments, the appointment messenger may send a status of the appointment to the computer in the doctor's office. This status signal may be sent after the message to the user regarding the appointment has been sent. In some embodiments, the status signal may be an acknowledgement that the message has been delivered to the user, or error signal that the message cannot be delivered for example because of a wrong telephone number for the user. In some embodiments, the appointment messenger may wait for an acknowledgement or confirmation from the user before sending a status signal to the computer in the doctor's office. If no response is received to one or more messages sent to the user, the appointment messenger may wait a certain time period relative to the occurrence of the appointment or based on when the one or more messages were sent to the user before sending the status signal. For example, the appointment messenger may send a first message to a user's wireline telephone and second message to the user's cellular telephone. If no response has been received by a time corresponding to two days before the appointment or within three days of sending the second message, the appointment messenger may send an error signal to the doctor's office, alerting them that no response has been received. To call more attention to a potential problem with the appointment, this error signal may bypass the software on the computer in the office used for entering appointments and may be sent directly to an e-mail account for an office staff worker. This direct communication to the worker may enable the worker to contact the client again until the client is reached, possibly avoiding the user missing the appointment and wasting a valuable appointment time period.

In some embodiments, an administrator or other person in an office may wish to know the status of one or more appointments or for example, all appointments on a given day. The administrator may enter the status request on the computer in the office which may send the status request to the appointment messenger. The appointment messenger may respond with the status of the appointment(s), indicating for example if one or messages were delivered, if the appointment has been confirmed, no messages were delivered, one or messages are scheduled to be delivered, etc.

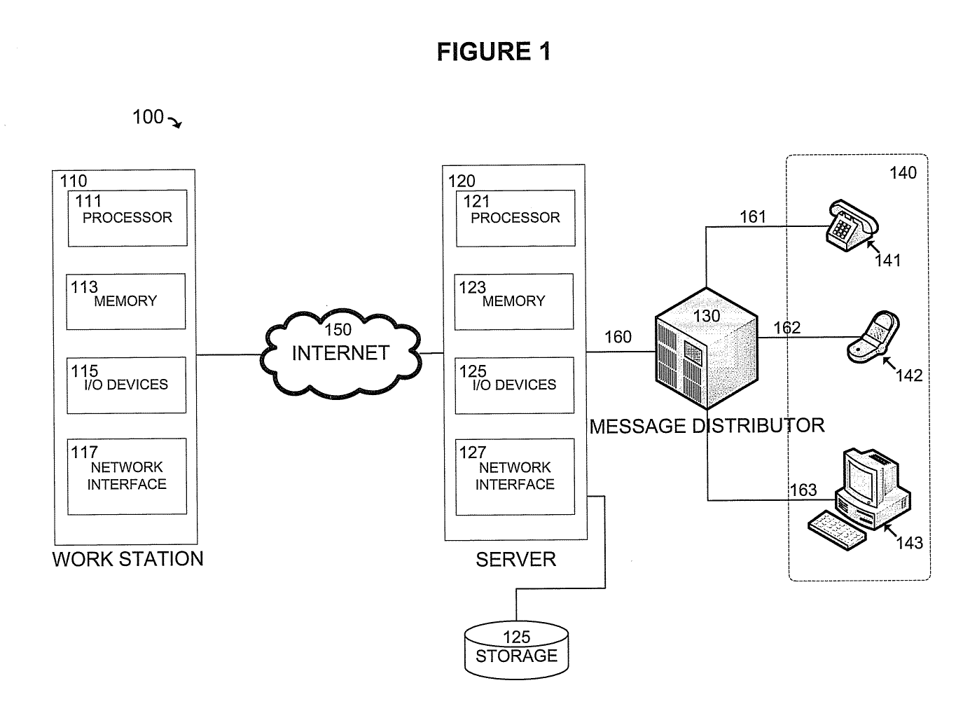

Reference is now made to FIG. 1, which is a simplified block diagram of a system for sending messages in accordance with an embodiment of the present invention. System 100 may include workstation 110, typically operated by the office staff in a professional service office, such as for example an administrative assistant in a doctor's office or dentist's office, to enter and manage appointments for users (e.g., patients), server 120 for hosting or executing a system or service for sending messages related to appointments and an associated storage 125, message distributor 130 for sending messages to client devices, and client devices 140 including client devices 141, 142, and 143. As an example only, only a single workstation 110 and three client devices are shown, but other numbers of workstations 110 may be used. Further, other or different components may be used, and components may be omitted. Components may be combined: e.g., server 120 and message distributor 130 may be combined. Workstation 110 may be connected to server 120 via a network 150, which may be for example a public network such as for example the Internet or other such public network. Similarly, message distributor 130 may be connected to server 120 via network 160, and client devices 141-143 may be connected to message distributor 130 by networks 161-163 respectively. Network 160 may be the same network 150 such as a public network or a private network or other network connection. Networks 161-163 may be whatever networks are appropriate to connect with client devices 161-163. Other logical elements, components, or networks may also be included in system 100. While in one embodiment workstation 110 is associated with and used by an organization such as a medical provider's office, other organizations or individuals, such as for example government agencies, may use embodiments of the present invention.

Workstation 110 may be used by a professional office staff worker such as for example an administrative assistant who is entering information regarding a new appointment for a user of the present invention, e.g. a client of the office, having one or more client devices 140 that are capable of receiving a message regarding the appointment. Workstation 110 may be or include any general purpose computer capable of supporting an application for entering information regarding appointments, for managing and tracking the status of the appointments, for sending signals to server 120 regarding the appointments, and for receiving status updates from server 120 regarding the appointments. Such general purpose computers may include for example a personal computer or other computer, or any other suitable device such as a cellular telephone, personal digital assistant (PDA), video game console, etc.

Workstation 110 may include a processor 111, a memory 113, input/output (I/O) devices 115, and network interface 117. Other components or logical elements may also be included in workstation 110. Processor 111 may be or include any controller, processor (e.g., central processing unit or “CPU”) or logical processors for controlling and executing instructions on workstation 110. In some embodiments, processor 111 may include one or more multi-core processors or multiple processing units.

Memory 113 may be or include, for example, any type of memory or memory device, such as static or dynamic random access memory or magnetic or optical disk memory. Such memory devices may include and are not limited to dual in-line memory modules (DIMMs), dynamic random access memory (DRAM), devices, synchronous dynamic random access memory (SDRAM) devices, double data rate (DDR) SDRAM devices, or other volatile or non-volatile memory devices suitable for server or general applications. Memory 113 may be used to store instructions to be executed by and data to be operated on by processor 111, or any such information in any form, such as for example operating system software, application software, or user data.

I/O devices 115 may be or include Industry Standard Architecture (ISA) devices, Peripheral Component Interconnect (PCI) devices, PCI Express devices, Universal Serial Bus (USB) devices, Small Computer System Interface (SCSI) devices, and/or other standard or proprietary I/O devices suitable for server, personal computer, or general applications. These I/O devices 115 may be or include for example a display device for an operator, e.g. a monitor, keyboard and cursor control devices, including an input unit, e.g., a keyboard, mouse, touch-pad, or other suitable pointing or input device for accepting input, alterations and/or selections, for example, from a user, audio I/O, communications devices, including modems and network interfaces, and data storage devices. Other I/O devices are also possible.

Network interface 117 may be or include, for example, any interface component able to transmit and or receive communications via a wired or wireless link. Network interface 117 may be implemented using for example a network interface card, a transceiver, a separate transmitter and receiver, or one or more units able to perform separate or integrated functions of transmitting and/or receiving wire or wireless communication signals, blocks, frames, transmission streams, packets, messages and/or data.

In some embodiments, more than one workstation 110 may be present in an organization or professional office for collocated professionals that may schedule appointments in the same location. Furthermore, system 100 may be capable of sending messages for multiple workstations 110 located in multiple offices serving multiple professionals. Typically, system 100 organizes messages and message sending by location (e.g., doctor's office), although other methods are within the scope of embodiments of the invention. Other configurations for multiple workstations 110 are also possible.

Server 120 may serve as the host for an application or applications that may perform one or more of the following functions, or other functions: receive signals from workstation 110, store some or all of the contents of the signals, send messages to one or more client devices 140 of a user, receive messages from one or more client devices, and send status messages to workstation 110. Server 120 may be or include any computer capable of hosting a process as disclosed herein, and applications for executing a system or service for sending and receiving messages and signals regarding appointments to and from client devices 140 and workstation 110. Other or additional components such as for example, network interface hardware, may be included.

Storage 225 may be or include any type of memory or memory device, such as static or dynamic random access memory or magnetic or optical disk memory as appropriate to store information as needed by server 120 to execute its functions including but not limited to instructions for execution, software applications, and data accessed by software applications such as for example a database or other data structure for retaining data regarding appointments and users.

Message distributor 130 may be or include any computer or other hardware capable of receiving messages from server 120 and distributing them via the appropriate networks or communications channels to client devices 140. In some embodiments, message distributor 130 may also be capable of receiving, for example, confirmations or acknowledgements from client devices 140 and forwarding them to server 120. Message distributor 130 may also be capable of aggregating content from multiple servers 120 as well as from multiple sets of client devices 140.

Server 120 may include a processor 121, a memory 123, I/O devices 125, and network interface 127. Other components or logical elements may also be included in server 120. Processor 121 may be or include any controller, processor (e.g., a CPU) or logical processors for controlling and executing instructions on server 120. In some embodiments, processor 121 may include one or more multi-core processors or multiple processing units.

Memory 123 may be or include, for example, any type of memory or memory device, such as static or dynamic random access memory or magnetic or optical disk memory. Such memory devices may include and are not limited to DIMMs, DRAM devices, SDRAM devices, DDR SDRAM devices, or other volatile or non-volatile memory devices suitable for server or general applications. Memory 123 may be used to store instructions to be executed by and data to be operated on by processor 121, or any such information in any form, such as for example operating system software, application software, or user data such as appointment data.

I/O devices 125 may be or include ISA devices, PCI devices, PCI Express devices, USB devices, SCSI devices, and/or other standard or proprietary I/O devices suitable for server, personal computer, or general applications. I/O devices 125 may be or include for example keyboard and cursor control devices, including an input unit, e.g., a keyboard, mouse, touch-pad, or other suitable pointing or input device for accepting input, alterations and/or selections, for example, from a user, audio I/O, communications devices, including modems and network interfaces, and data storage devices. Other I/O devices are also possible.

Network interface 127 may be or include, for example, any interface component able to transmit and or receive communications via a wired or wireless link. Network interface 127 may be implemented using for example a network interface card, a transceiver, a separate transmitter and receiver, or one or more units able to perform separate or integrated functions of transmitting and/or receiving wire or wireless communication signals, blocks, frames, transmission streams, packets, messages and/or data.

To be capable of communicating with the appropriate variety of client devices 140, message distributor 130 may have the capability to transmit in different mediums such as for example voice based telephone calls (land-line based or cellular), text or SMS messages, e-mail messages, facsimile, and other media as known and employed for routine communications with users or clients. Accordingly, message distributor 130 may be able to generate messages in all such appropriate media such as for example by simulating a voice in a telephone call. In some embodiments, various templates for messages may be used for each different message type according to such parameters as for example client device 140, language, message required, etc.

Similarly, when a response is required from a user, e.g. an acknowledgement or confirmation, these messages may take specific forms as specified in the message sent to the user or elsewhere and according to the signal type or medium used. Message distributor 130 may be able to receive and process these formatted message responses as well, for example receiving and processing touch-tone key presses or human voice commands or responses.

In some embodiments, message distributor 130 may also be capable of recording message parameters for each message sent to a client device 140 such as for example, network type message length, the sender (office of workstation 110), recipient, template used, message type. These recorded parameters may allow a billing system for the operation of the appointment messaging system to charge, for example, office professionals by expenses incurred for all messages sent and received. In this manner, a customer, such as for example a doctor's office, using the present invention may be billed according to the parameters of the signals by which messages are sent.

In some embodiments, some or all of the functionality of message distributor 130 may be incorporated into server 120, although the invention is not limited in this respect. Other hardware and software configurations for the functionality of message distributor 130 are also possible.

Client devices 140 may be any communications device by which a user, e.g. a client, may receive messages regarding an appointment. In the embodiment of FIG. 1, non-limiting examples of three devices are shown: wireline telephone 141, cellular telephone 142, and personal computer 143 capable of receiving for example e-mail messages or instant messages. However, the invention is not limited in this respect; other communications devices and communications media for reaching users such as for example a personal digital assistant (PDA), a facsimile machine, or paging device may also be used. In some embodiments client devices 140 may also be used by a user to respond to or acknowledge that a message regarding an appointment has been received. Such responses, in some embodiments, may be sent via a different client device 140 than the one on which a message was received.

Network 160, which connects server 120 and message distributor 130, and networks 161-163 may be any local network or publicly accessible network such as the Internet; networks 160-163 may be the same network (e.g., the Internet), or may be a combination of networks. Access to networks 160, 161, and 162 may be through wire line, terrestrial wireless, satellite or other systems well known in the art.

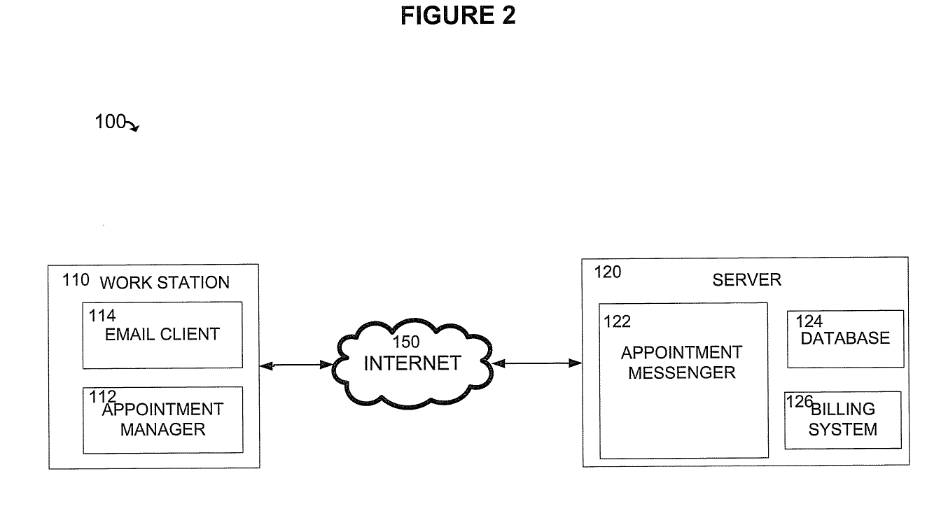

Reference is now made to FIG. 2, which is a simplified software block diagram of workstation 110 and server 120 of system 100 for appointment messaging in accordance with some embodiments of the present invention. Although operations are assigned to the different software components of system 100 as these entities are described herein, in other embodiments the operations may be performed by different entities, having different structures.

Workstation 110 may include software components such as for example an appointment manager 112 for tracking and managing appointments and an e-mail client 114 capable of sending and receiving e-mail messages external to appointment manager 112. Additional or alternative software components or modules may also be included. For example, a web browser such as for example Internet Explorer® sold by Microsoft Corporation may also be used to send and receive messages external to appointment manager 112.

Appointment manager 112 may be or include a proprietary or commercially available software package for managing appointments such as for example DentalVision®, Dentrix®, and EasyDental® from Henry Schein® Practice Solutions, MacPractice® from MacPractice, Inc., and Patterson EagleSoft® from Patterson Dental Supply. An office worker or other person operating workstation 110 may be able to enter information regarding an appointment and a user into appointment manager 112 using for example I/O devices such as I/O devices 115. Appointment manager 112 may be capable of storing the information, communicating some or all of the information to server 120, receiving status information from server 120, displaying and/or alerting an office worker as to the status of an appointment as well as other functions.

In some embodiments, appointment manager 112 may be a pre-existing software component or element designed to operate as an “off-the-shelf” stand-alone package. In these instances, some modification to appointment manager 112 may be made to enable it to communicate with server 120. These modifications may include for example adding the capability to send and receive structured messages regarding appointments as discussed herein. For some existing software, the use of for example extensible markup language (XML) formatting or other well-published messaging formats may ease the implementation of such modifications.

E-mail client 114 may be or include any e-mail client application capable of receiving e-mail messages or other communications independently of, e.g. out of band from, appointment manager 112, such as for example Microsoft Outlook® or Outlook Express®. For example, server 120 may send an error message that a user has not responded to one or messages regarding an appointment directly to e-mail client 114, bypassing appointment manager 112. The e-mail messages may be accessed by a worker in the organization responsible for appointments. In some embodiments, e-mail client 114 may be used to transmit as well as receive messages from server 120 independently of appointment manager 112. In some embodiments, e-mail client 114 may be a web browser such as for example Microsoft Internet Explorer® used to access a Web based e-mail server. Other e-mail access systems as known that operate independently from appointment manager 112 may also be used for e-mail client 114. Alternatively, in some embodiments e-mail client 114 may be installed on a separate workstation 110 than appointment manager 112. Other configurations for e-mail client 114 are also possible. As a further alternative in some embodiments, a different component outside of appointment manager 112 and/or workstation 110 operating independently of appointment manager 112 may receive messages such as status messages from server 120. For example, server 120 may alert a receptionist at a doctor's office that one or more patients have not confirmed upcoming appointments or that a patient reminder did not reach the patient because of an incorrect telephone number. Server 120 may send an e-mail directly to e-mail client 114, bypassing appointment manager 112, effectively creating an out-of-band communications path for alerting staff members to potential problems with upcoming appointments and/or message delivery.

Server 120 may include software components such as for example an appointment messenger 122 for sending and receiving messages regarding appointments, database 124 for storing appointment related information, and billing system 126 for tracking expenses related to the transmission of messages regarding appointments. Additional or alternative software components or modules may also be included. Furthermore, the components as described herein may be located on separate hardware platforms other than server 120.

Messages sent by appointment manager 112 may be received at server 120 by appointment messenger 122 which may also send status and other messages or signals to appointment manager 112. Appointment messenger 122 may be or include software process or application capable of, for example, receiving signals and/or messages regarding appointments for users from appointment manager 112, for processing those signals and/or messages, for determining when to send and sending messages to one or more client devices 140, for receiving acknowledgements from one or more client devices 140, and for conveying status information to either appointment manager 112 or e-mail client 114, although the invention is not limited in this respect. For example, appointment messenger 122 may receive a message from appointment manager 112 containing information regarding a newly scheduled appointment. Appointment messenger 122 may store the information, schedule a reminder message to be sent to a client device 140 based on the information, wait for a confirmation from the client device 140, and send a status message back to appointment manager 112. If, for example, appointment messenger 122 receives a message from appointment manager 112 containing a change to an existing appointment, appointment messenger may, based on this information, update or cancel scheduled reminders and other messages accordingly. Other functions of appointment messenger 122 are also within the scope of the invention.

Database 124 may be or include any software process or application for storing and retrieving information, files, or a plurality of documents, such as a database system such as, e.g., a relational database, as well as associated hardware. Although the invention is not limited in this respect, items stored in database 124 may include for example user profile data such as user name, identifiers to access preferred client devices such as telephone numbers or e-mail addresses, professional service related data, such as for example user medical information if the user is a doctor's patient as well as the doctor's name, appointment date and time, date and time for one or more reminders to be sent, criteria for determining when an error signal may be sent to workstation 110, and other such information as may be relevant to the appointment messaging services of the present invention. It will be appreciated by those skilled in the art that one or more of appointment messenger 122 and database 124 may be combined or separated into one or more physical units or software modules able to perform separately or together functions of the units shown in the embodiment of FIG. 2.

Billing system 126 may be or include any software process or application for recording and storing expenses incurred in the transmission and receipt of messages and signals associated with appointments of the present invention. In some embodiments, some or all of billing system 126 may be remotely located from server 120 such for example on other servers and may also have additional capabilities as needed to support proper billing of clients for a service utilizing the presently invented appointment messaging system. In some embodiments, billing system 126 may be built as a collection of components in for example JAVA to allow the components to be distributed over one or more servers 120 or other components of system 100 and to provide sufficient billing and tracking capacity.

For proper reconciliation of expenses, billing system 126 may also communicate with appointment manager 112, storage 125, and message distributor 130 or other components of system 100 to determine and receive values for the parameters needed to track and record message and/or signal transmission and receipt expenses. These parameters may include for example signal type or communications media, message length or size, transmission duration, time of day sent, priority, etc. Other parameters as known may also be included for tracking.

One advantage of some embodiments of the present invention with respect to billing may result from the centralized distribution of messages. Having all messages sent to and received from client devices 140 emanating from a single source, e.g. message distributor 130, may enable billing system 126 to consolidate message related expense tracking more readily than prior art systems that send signals via different distribution systems for different signal types. A further benefit of centralized distribution may be lower distribution costs due to scaling from the higher volume of transmissions by a single source.

The communication of data between workstation 110 and server 120 may include a number of different message and/or signal types with information regarding one or more appointments contained in each and may occur in both directions between workstation 110 and server 120. If network 150 is a public network such as for example the Internet, the communications may be secure to prevent undesired visibility to outside entities. Although not limited in this respect, some embodiments of the present invention may utilize a hypertext transfer protocol (HTTP) and a hypertext transfer over a secure socket layer (HTTPS) connection. Other techniques for securing the communications between workstation 110 and server 120 are also possible.

Because the transmission of messages may occur immediately for example after an office worker makes or completes an entry in appointment manager 112, e.g. in real time, the format of messages may be required to accommodate dynamic message generation and provide adequate structure to accommodate the variety of messages and data types employed by embodiments of the present invention. In some embodiments, messages may be formatted according to a protocol for transmitting and receiving structured data in a message or signal without requiring transmission of files such as for example in accordance an extensible markup language (XML) specification, although the invention is not limited in this respect. Other formats and structures for messages are also possible.

Signals and messages originating at for example appointment manager 112 on workstation 110 may include several types such as for example setup requests, appointment information updates, send, delete, verify user, and status requests. Other message types are also possible. Setup request messages may include for example messages used to create an entry for an appointment on appointment messenger 122, the appointment also being recorded on terminal 110. Alternatively, if terminal 110 is for example a thin client, appointment entries may be stored remotely from terminal 110 for example either offsite or on some other storage device. Although the present invention is not limited in this respect, the information in these messages may include various attributes of a user's profile such as for example, user contact information (e.g., name, address, e-mail address, telephone number, cellular telephone number), preferred signal types (wireline telephone, cell telephone, text message, facsimile, etc.) and one or more preferred client device(s) 140; appointment information for the user such as for example, appointment place (e.g., with which organization, professional or office), date and time; and reminder related information such as for example time for one or more reminders to be sent, signal type of the one or more reminders, content of the one or more reminders, and parameters for when the organization or office entering the appointment information should be alerted for a problem in reaching the user. Appointment information sent from a workstation to a server may include for example data related to or derived from appointment information stored on a workstation. For example, a worker may enter a patient's appointment information in a certain format, and data describing that appointment, in another format, may be sent to a server. Other information relevant to the user, the appointment, and the client device 140, such as for example instructions to prepare for an appointment may also be included.

Appointment information updates may include messages sent from appointment manager 112 to appointment messenger 122 that change information regarding an established appointment such as for example in response to a user (e.g., patient) calling an office to cancel the appointment or in response to modifying information regarding an established user such as for example a new address. In some embodiments, changing information may be implemented by deleting existing data and storing a new, e.g. replacement set of data. Other update messages and implementations for changing information regarding established appointments are also possible.

Status requests sent from workstation 110 may include requests to appointment messenger 122 for an update as to the status of one or more existing appointments or users. These requests may be submitted based on user, time period, one or more appointments or other parameters of categorization for appointments. In some embodiments, status requests may be passed to server 120 from appointment manager 112. Alternatively, status requests may be sent by e-mail client 114 to server 120. Other sources for status requests such as for example office staff with remote access are also possible.

The messages or signals from server 120 to workstation 110 may include for example responses to status requests, acknowledgements or other confirmations that messages from workstation 110 have been received, error messages, and error signals or other alert messages. Other messages and signals are also possible. Responses to status requests may include information on appointments or users corresponding to that requested by workstation 110. Acknowledgements may include acknowledgements that new information submitted to server 120 has been received and processed, acknowledgements that messages to users have been delivered to one or more client devices 140, and other such messages. In the event that a setup request or other message from workstation 110 for example includes incorrect information or is formatted incorrectly, server 120 may send an error message back to workstation 110. Furthermore, if a message fails to reach the client device of a user or a user does not acknowledge or confirm receipt of a message, or there is another error in the sending of a message to or via a client device, server 120 may send an error signal back to appointment manager 112 or alternatively to e-mail client 114. In some embodiments, appointment messenger 122 may be configured to send an error signal or other notification to an office if a programmable number of messages fail to be delivered to a user or are not acknowledged by a user.

In some embodiments, the communications between workstation 110 and server 120 regarding a particular appointment that has been stored at server 120 may be associated with that appointment by a universally unique identifier (UUID). Other identifiers, other than a UUID, may be used. A UUID for an appointment may be assigned at server 120 for example when an appointment, created at appointment manager 112, is initially processed at server 120 and may be encoded into the content of any messages relevant to that appointment using for example an XML format, although other formats may be used. For example, a reminder message to be sent to a client device that is generated at server 120 may include a UUID for the appointment and/or a different UUID for the reminder for the appointment. Other messages such as status requests from appointment manager 112 and responses to the status requests from server 120 may also contain UUIDs.

In some embodiments, a UUID or other identifier for an appointment may be created at an element of system 100 other than server 120. In some embodiments, UUIDs may be generated in accordance with for example the International Standardization Organization/International Electrotechnical Commission (ISO/IEC) 11578:1996 standard. Other methods and standards for generating UUIDs that uniquely identify for example the appointment or reminder may also be used.

When server 120 receives a message or signal containing one or more UUIDs, appointment messenger 122 or another component may process the message or signal according to those UUIDs. Similarly, appointment manager 112 may process a status message from server 120 according to the one or more UUIDs contained in the status message.

Messages to client devices 140 may include for example reminders for appointments, instructions such as for example how to prepare for an appointment (such as directing a user such as a patient not to eat for 12 hours prior to an appointment), and changes in appointment scheduling, although the invention is not limited in this respect. The format and content of these messages may vary according to which client device 140 is receiving the message. For example, instructions for response may require pushing a button such as a touch-tone button for telephone call versus clicking or pressing on a reply button for responding to an e-mail or text message to a cellular telephone. Furthermore, in some embodiments, appointment messenger 122 may be capable of sending a configurable number of messages to one or more client devices 140 thereby increasing the likelihood that the user receives the message.

In addition to the messages to client devices 140 listed herein, instructions for confirming or acknowledging receipt of message or confirming an appointment may also be sent either together with or separately from a message to a client device 140. In some embodiments, the instructions for confirmation or acknowledgement may vary with the type of client device 140 receiving the message. For example, an autodialing telephone calling service may request the user to push a number button to confirm an appointment or alternatively to confirm by saying “confirm.” As a second example, a text message to a user's cellular telephone may instruct a user to press or click on the reply button to confirm an appointment. Alternatively, an e-mail message may prompt the user to reply to the message or click on a URL, e.g. a link to respond.

These confirmations or acknowledgements may be received for example by appointment messenger 122. In some embodiments, the confirmations or acknowledgements may first be received by message distributor 130 and then forwarded to appointment messenger 122. Alternatively, a user may contact the institution or office making the appointment directly for example by telephone to respond to a message, bypassing system 100 entirely.

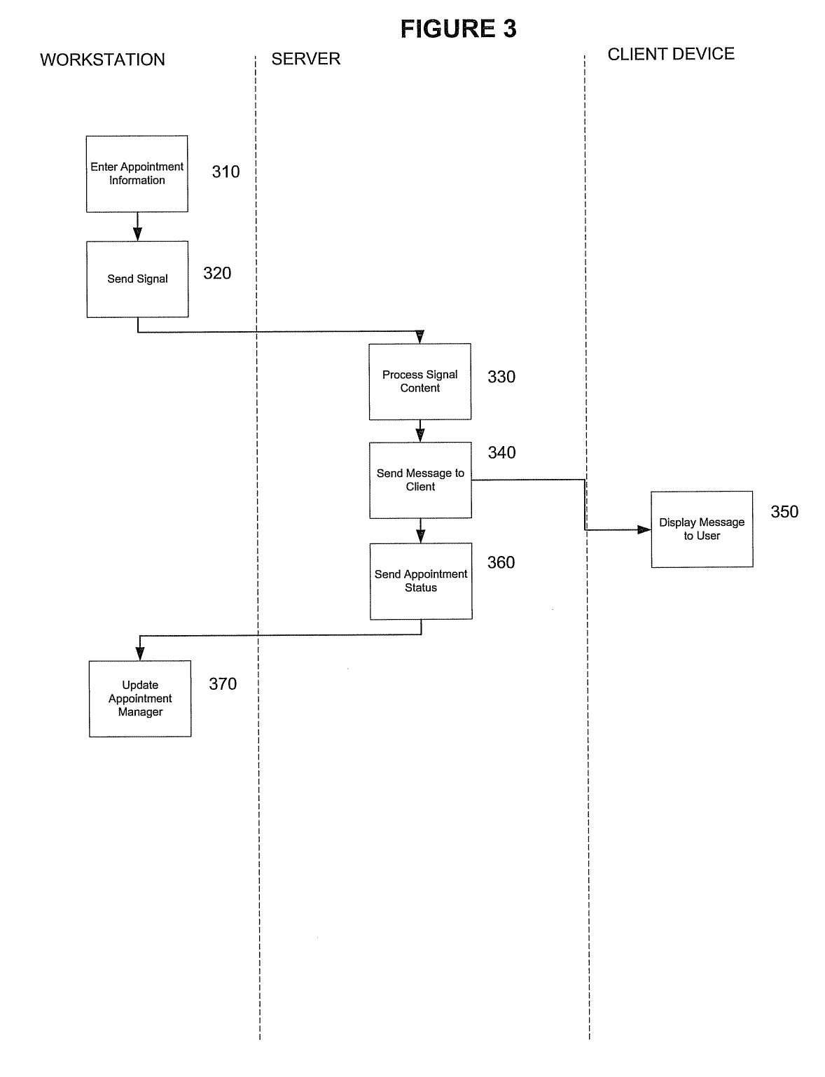

Reference is now made to FIG. 3, which is a flowchart illustration of a method for appointment messaging in accordance with some embodiments of the present invention. While operations are assigned to a workstation such as workstation 110, a server such as server 120, a message distributor such as message distributor 130, and client devices such as client devices 140 as these entities are described herein, in other embodiments the operations may be performed by different entities, having different structures. Furthermore, other or different operations or sequences may be performed.

An office worker at an organization such as professional service office, such as for example an administrative assistant at a doctor's office, may enter information regarding an appointment for a user or client on for example workstation 110 using appointment manager 112 (operation 310). The appointment may be a new appointment for an existing user, a new appointment for a new user, or an update to an existing appointment, although the invention is not limited in this respect. If the appointment is a new appointment or an update to an appointment for an existing user, the information entered may include parameters associated with the appointment such as for example, appointment date and time, instructions related to the appointment, and the like. The information may include for example a sequence of messages to be sent to the user such as a notification that the appointment has been made (e.g., sent on the day created), a confirmation request for the appointment sent several days before the appointment, and a reminder sent a few hours before the appointment. If the appointment is for a new user, additional information to complete a profile for the user such as for example contact information, preferred client devices 140, when to remind the user, etc. may also be entered

Once the information is recorded and processed by appointment manager 112, in operation 320 appointment manager 112 may send a signal over a network such as network 150 to for example server 120 hosting an appointment messenger such as appointment messenger 122. The sending of this signal may be triggered by or in response to, or substantially immediately after, the entry of the data in operation 310, or to the completion of the entry of the data, although the invention is not limited in this respect. For example, the sending of a signal including appointment information from appointment manager 112 to server 120 may not begin until the completion of the entry of the appointment information. The completion of the entry of the appointment information may cause appointment manager 112 to begin the process of transmitting the information. By contrast, in the prior arm an appointment messenger may only be updated on a pre-scheduled basis, and via a bulk data transfer including many appointments. The delay caused by waiting until a scheduled message delivery may result in reminders or messages being sent to users regarding appointments that have been cancelled or rescheduled. Immediate transmission of appointment messages, according to some embodiments of the invention, may alleviate this problem as appointment messenger 122 may always have the most current information available on scheduled appointments.

In some embodiments, the signal containing the appointment information may be formatted in accordance with a protocol for transmitting and receiving structured data in a message or signal without requiring transmission of files such as for example in accordance with an XML specification and sent over a secure network connection, for example an HTTPS connection. Other formats and other secure connections may also be used. The content of the signal may include at least a UUID for the appointment along with appointment date and time, reminder or notification data and time, and destination, e.g. a client device such as one of client devices 140. Different or alternative information may be included as well.

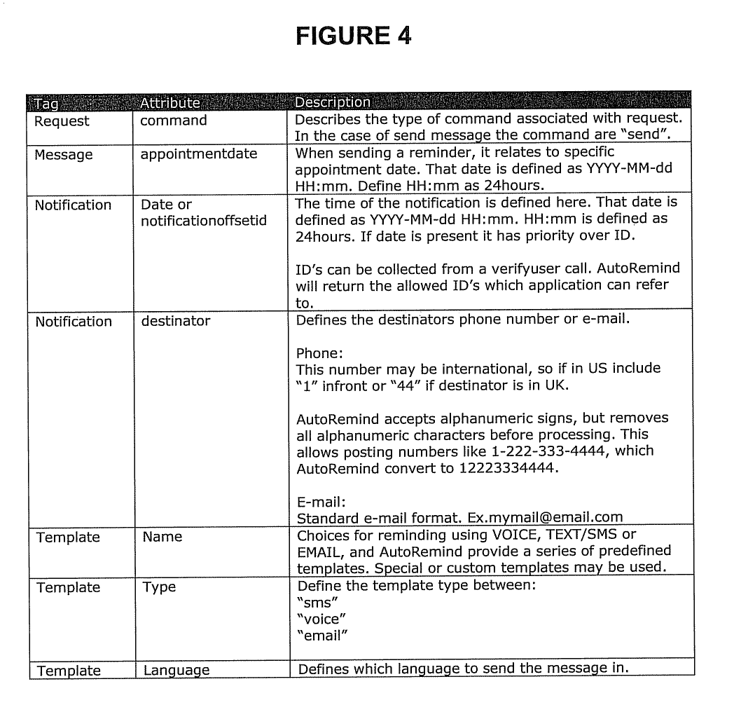

Reference is now made to FIG. 4, which is a table showing an example format for a message used to send appointment information to a server such as server 120 from a workstation such as workstation 110 in accordance with an embodiment of the invention. Although FIG. 4 shows one example format, the invention is not limited in this respect. Other names and formats, the type and number of elements, colors, and other aspects of message formatting for sending appointment information to a server may be used.

In the embodiment of FIG. 4, each line may define or assign a different value for each parameter required in the signal according to an XML format. In one embodiment an XML command for inclusion in a signal to server 120 may include instructions similar to the following:

<request command=″send″>
<message appointmentdate=″2007-11-10 10:00″ >
<notification date=″2007-08-04 09:35″ destinator=″1-555-555-5555″>
<template name=”standard” type=”sms” language=”us-en”/>
</notification>
</message>

Additional or alternative XML structures and commands may also be used.

In operation 330, server 120 may receive the signal and may process the signal according to appointment information contained in the signal using for example appointment messenger 122. In some embodiments, processing may include storing appropriate appointment and user information in for example database 124 and for example determining when to send a message to a user via a client device 140. In some embodiments, processing may include generating a UUID or other identifier for the appointment, and/or generating a different UUID for the reminder messages to be sent to one or more client devices 140. Subsequent status requests by appointment manager 112 and responses by server 120 may then refer to the UUID or other identify of the appointment or reminder to uniquely identify the respective appointment or reminder.

In operation 340, appointment messenger 122 may send a message to a client device 140 over a network such as one of networks 161-163 according to parameters either previously established and stored in database 124 such as for example a message template or as contained in the signal sent in operation 320. In some embodiments, operation 340 may be repeated for a plurality of messages, e.g. appointment messenger 122 may send a plurality of messages to one or more client devices 140 with each message sent at a different time prior to the scheduled appointment.

In some embodiments, the message sent to a client device may be a reminder message. One example of such a reminder message to a doctor's patient to be delivered via a wireline or cellular telephone may be “This is a message from Dr. X to remind you about your appointment tomorrow the 24^{th} at 11:00 AM. Please press ‘1’ to confirm your appointment.” In this message, the previously established parameters may include the doctor's name, the date and time of the appointment, whether or not a confirmation is requested, and (although not apparent directly from the message) the telephone number to be dialed. Other or different information may be included.

Alternatively, in some embodiments a default format or template may be used if no specific template is specified. In some embodiments, appointment messenger 122 may send the message using a message distributor such as message distributor 130 for distributing and receiving all messages between appointment messenger 122 and client devices 140. Message distributor 130 may be collocated with appointment messenger 122 or remotely located in which case the message may be sent to message distributor 130 over for example network 160. Message distributor 130 may determine which of possible client devices 140 to which a message should be sent according to parameters included in the message such as for example a telephone number for wireline telephone device 141 or e-mail address accessible on personal computer 143. Alternatively, appointment messenger 122 may determine which network and corresponding client device and send the message directly or through a different content distribution system as known.

The message to the user may also be or include for example a request to confirm an appointment, instructions regarding an appointment, a notification that an a new appointment has been made, or more than one of these message types, although the invention is not limited in this respect. Other messages to the user are also within the scope of the invention.

In some embodiments, each different message type may be transmitted using a different message template. For example, a different message template may be used for a voice call than for an SMS or text message to cellular telephone 142. Additionally, a different message template may be used for each different type of client device 140.

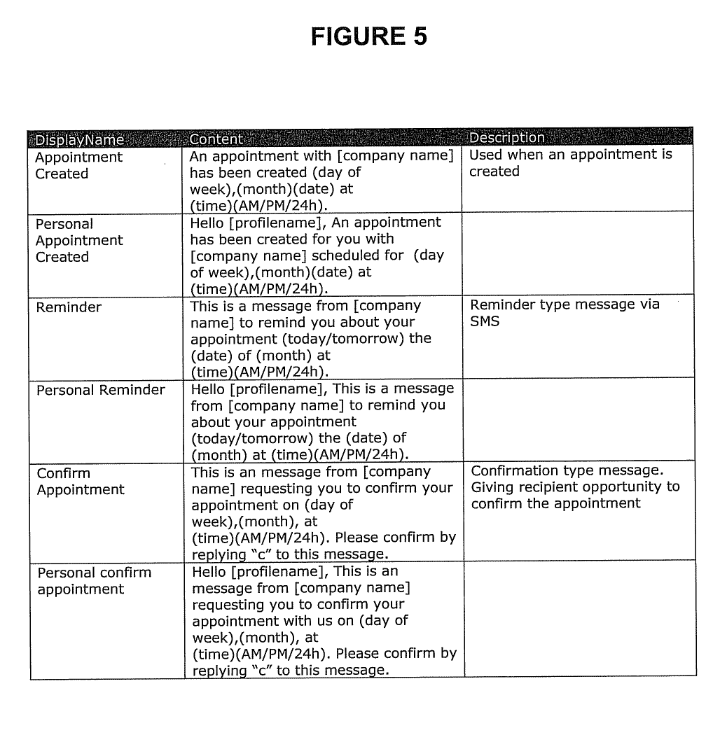

Reference is now made to FIG. 5 which is a table showing an example of a format for an XML command sequence containing a text or SMS template to send to a client device in accordance with an embodiment of the invention. Although FIG. 5 shows one example format, the invention is not limited in this respect. Other names and formats, the type and number of elements, colors, and other aspects of formatting an XML command sequence containing a text or SMS template may be used. Furthermore, other messages, with other types of reminders, may be used. The embodiment of FIG. 5 shows a template to be sent for example from appointment messenger 122 to message distributor 130 for transmission in accordance with an XML specification although other specifications and formats may be used. An XML command sequence corresponding to this table may be similar to the following:

```
    <notification date=″2003-08-04 09:35″ destinator=”1-555-555-5555”
<template name=″personal″ type=”SMS” language=”us-en”>
  <values>
    <profilename>John</profilename>
  </values>
</template>
</notification>
```

Once the message is received at a client device 140, the device may display or present the message to the user (operation 350). In the case of a wireline telephone 141 or cellular telephone 142, the presentation may be in the form of a pre-recorded message, pre-recorded segments stitched together to customize the message, and/or messages created using artificial speech generation. Other methods of presenting the message to the user such as printout a facsimile transmission are also within the scope of the invention.

In operation 360, appointment messenger 122 may send a signal or message to workstation 120 containing a status of the appointment according to for example a message status indicator. In some embodiments, the sending of the status of the appointment may be caused by or in response to for example appointment manager 112 sending a status request to server 120. The status of the appointment may include at least the UUID of the appointment and for example a confirmation that a message has been sent to the user or alternatively an error message that the message has not been delivered, although the invention is not limited in this respect. For example, if a message is delivered via automated voice dialer or similar technology to a cellular telephone or wireline telephone with voicemail capability and a voicemail is left for the user, the status may include that a message to the user has been delivered. As an alternate example, if appointment messenger 122 is aware that an attempt to send a message to a wireline telephone 141 failed because the telephone number does not work or is otherwise incorrect, appointment messenger 122 may send appointment manager 112 a status of the appointment including the comment “the telephone number for the patient is incorrect or out of service.” Other status messages are also possible

Once workstation 110 receives the status message, appointment manager 112 may be updated with the contents of the status message in operation 370. This update may be processed according to the UUID of the appointment. In some embodiments, appointment manager 112 may display or present the updated status of the appointment to an office worker. Displaying the updated status may enable an office worker to fill an appointment cancelled by a patient in response to a message.

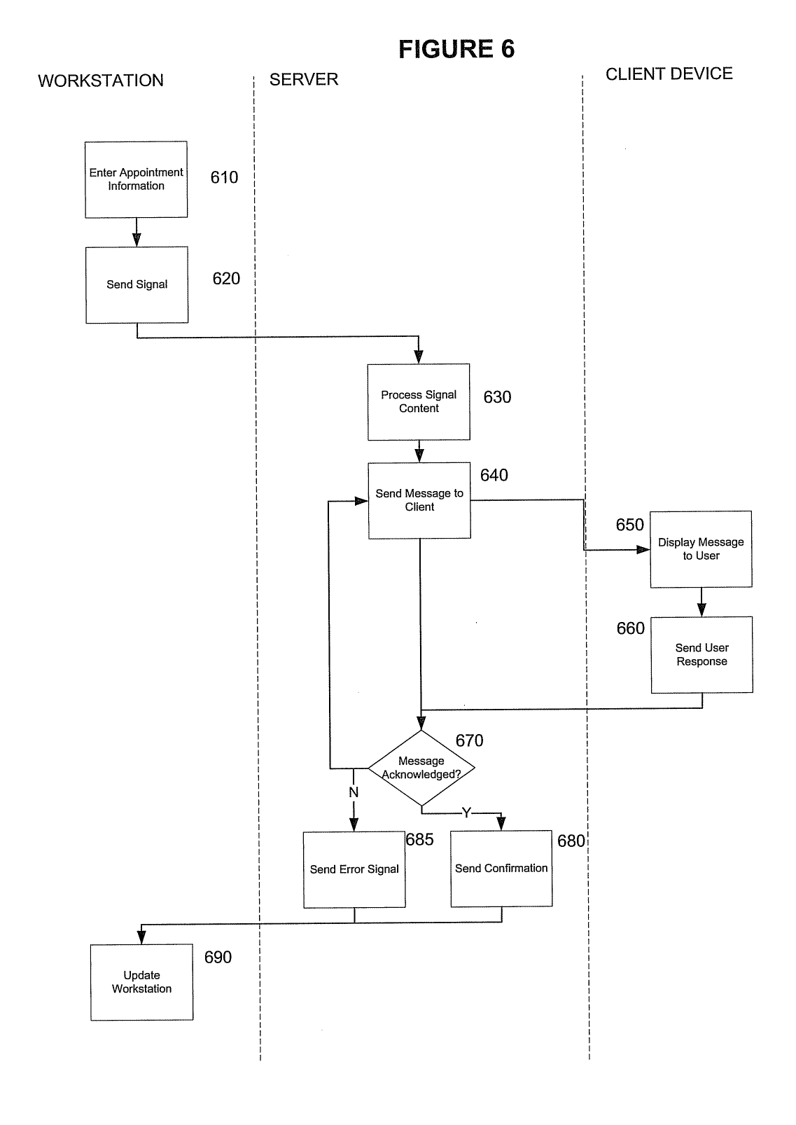

Reference is now made to FIG. 6, which is a flowchart illustrating a method for appointment messaging in accordance with embodiments of the present invention. While operations are assigned to a workstation such as workstation 110, a server such as server 120, a message distributor such as message distributor 130, and client devices such as client devices 140, in other embodiments the operations may be performed by different entities, having different structures. Furthermore, other or different operations or sequences may be performed.

In the embodiment of FIG. 6, operations 610-650 may proceed in the same manner as operations 310-350 of FIG. 3, although the invention is not limited in this respect. As an alternate, the method may proceed to operation 670 if the acknowledgement is a confirmation from for example message distributor 130 that the message was delivered. Other or additional operations may be included. For the embodiment of FIG. 6 the message displayed to the user on a client device 140 may request that the user respond to the message with an acknowledgement or confirmation as discussed herein. Furthermore, in some embodiments, the message to the user may include instructions as to how the user should respond, e.g., acknowledge or confirm that the message was received or that the user will keep the appointment. In operation 660, the user may send a response, typically on the same network as that on which the message sent to the user, for example one of networks 161-163 as the message sent to the client device 140. The response may be as discussed herein and may be in the form of for example a blank or other text message sent from the user by pressing the reply key on a cellular telephone 142 or a blank or other e-mail message sent by pressing the reply button on an e-mail client of a client device 140. Alternately, a user may press one of the dialing keys on a telephone in response to a voice message delivered on for example wireline telephone 141 or cellular telephone 142.

In some embodiments, this response may be sent back to message distributor 130 and forwarded to server 120, although the invention is not limited in this respect. Alternatively, the response may be sent directly back to server 120. Other methods of responding are also possible.

In some embodiments, the user may respond, e.g. acknowledge or confirm, using a different signal type than the one used to send the message to the user. For example, a user may receive a message regarding an appointment on wireline telephone 141 and may respond to the office with a confirmation on cellular telephone 142. For example, a patient may check his or her voicemail on a wireline telephone and respond to a message regarding a doctor's appointment by placing a telephone call to the doctor's office on a cellular telephone. In this circumstance, a worker at for example workstation 110 in the office may enter the confirmation in appointment manager 112, which may in turn send a signal to for example appointment messenger 122 of server 120 notifying appointment messenger 122 that the appointment was confirmed. Other techniques for acknowledging a message or confirming an appointment and relaying the acknowledgement or confirmation to server 120 are also possible.

In operation 670, appointment messenger 122 may check to see if an acknowledgement or confirmation regarding a message or appointment was received from the user or if for example message distributor 130 was able to deliver the message. In some embodiments, appointment messenger 122 may be configured to check for acknowledgements for a specified period of time after a message is sent to the user. For example, appointment messenger 122 may send, one week in advance of an appointment, a text message to a patient's cellular telephone 142 via message distributor 130 reminding the patient of the upcoming appointment and also including instructions for responding to the text message. If no response is received for three days or if message distributor 130 was unable to deliver the message, then appointment messenger 122 may alert a staff member in the doctor's office that no confirmation has been received yet.

Additionally or alternatively, the timing of appointment messenger 122's checking for acknowledgements and confirmations may be associated with or based on the date and time of the user's appointment. For example, appointment messenger 122 may check to see if a user has confirmed an appointment one day prior to the appointment. Other references for or events on which to base determining the timing of operation 670 are also possible.

If a response, e.g. an acknowledgement or confirmation, from the user has been received, appointment messenger 122 may send a signal, e.g. a status message, containing this information and the UUID of the appointment to workstation 110 over network 150 (operation 680). In operation 690, appointment manager 112 may be updated with the contents of the status message according to the UUID of the appointment. Appointment manager 112 may, in some embodiments, display this information to for example an office worker at workstation 110.

Alternatively, in some embodiments no signal may be sent to workstation 110 when an acknowledgement is received, e.g. operations 680 and 690 may be omitted. For these instances, appointment manager 112 may be updated for example when it receives a reply to a status request that it sends to server 120 regarding the appointment, e.g. the status request from appointment manager 112 causes server 120 to send a status message.

However, if in operation 670, it is determined that a response, e.g. an acknowledgment or confirmation has not been received after one or more messages have been sent to one or more client devices 140 or within a configurable time period after one or messages have been sent or that one or more messages were not successfully delivered to one or more client devices 140, an error signal may be sent to for example workstation 110 (operation 685). The error signal may include at least the UUID of the appointment and an indication that no response has been received. For example, if appointment messenger 122 is aware that an attempt to send a message via e-mail failed because the e-mail address was invalid or due to another delivery problem, appointment messenger 122 may send an error signal including, for example, the comment or descriptor “the patient's e-mail address is not valid or out of service.” Alternatively, appointment messenger 122 may receive a response from the user requesting a cancellation of or a change to an upcoming appointment in which case the error signal may include an indication of the desired change.

In some embodiments, the error signal may only be sent in response to a status request from appointment manager 112. To maintain current information on scheduled appointments, appointment manager 112 may send status requests for appointments periodically, for example hourly or daily. The frequency of these status requests may vary for different appointments and may depend for example on the relative timing of the appointments. For example, appointment manager 112 may send status requests more often for an appointment that is two days away than for one that is three weeks away.

In some embodiments, the error signal may be sent to for example e-mail client 114 of for example an administrator in a doctor's office, thereby bypassing appointment manager 112 (although the messages may be sent in parallel to both entities) and possibly alerting the office staff more directly and immediately about a potential problem with an upcoming appointment. For example, a receptionist responsible for scheduling appointments in a doctor's office or other organization may receive an e-mail message from appointment messenger 122 stating for example “Mr. Y has not yet confirmed an appointment scheduled with Dr. X for tomorrow at 10 AM.” Other methods for sending an error signal that bypass or are sent in parallel to appointment manager 112 to designated office workers, e.g. are out of band from appointment manager 112 and are receivable directly by office staff may also be used.

With this information, an office can consider other methods to contact the user or possibly consider rescheduling the appointment. Alternatively, an office can contact the user directly without relying on server 120 or other components of system 100.

Once the error signal has been received, appointment manager 112 may be updated in operation 690 as discussed herein. Additionally, the method may proceed back to operation 640 in a further attempt to reach the user on either the same client device 140 or a different client device 140. For example, if wireline telephone 141 was contacted in the first operation 640, cellular telephone 142 may be contacted in the second attempt. In some embodiments, the order of which client devices 140 to be contacted in successive attempts may be individually incorporated in the user's profile and/or stored in database 125. Alternatively, a default order of client devices 140 may be used. Operations 650-690 may proceed as previously discussed.

In some embodiments, if no acknowledgement is received in operation 670, the method may proceed back to operation 640, e.g. appointment messenger 122 may attempt to send a second or further message to either the same or different client device 140 depending on how many messages appointment messenger 122 is configured to send before sending an error signal. For example, if a user does not respond to a first message delivered to a wireline telephone 141, appointment messenger 122 may attempt to send a message to cellular telephone 142. If no acknowledgement (response) is received after the second message, appointment messenger 122 may then send the error signal in operation 685. In some embodiments, the method may additionally revert back to operation 640 as appointment messenger 122 may make further attempts to reach the user. Some or all of operations 610-690 may be repeated, as multiple reminders may be sent to the user. For example, a notification that an appointment is created may be sent to the user substantially soon after the appointment is created. A request to confirm the appointment may subsequently be sent to the user several days before the appointment. A reminder may be sent to the user if the user does not confirm that the user will attend the appointment or that the user received an appointment message (a reminder may be sent regardless). Depending on the settings for the user, a reminder may be sent to a portable device of a user on the day of the appointment. The settings may be established for example according to a profile of the patient or a preset profile for multiple patients for a doctor from appointment manager 112. Other methods for establishing the reminder settings of a user are also possible.

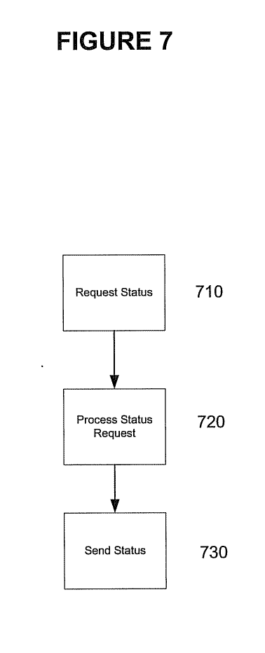

Reference is now made to FIG. 7, which is a flowchart showing a method for requesting a status update for one or more appointments and/or reminders previously recorded on for example server 120 in accordance with an embodiment of the invention. While operations are assigned to a workstation such as workstation 110 and a server such as server 120 as these entities are described herein, in other embodiments the operations may be performed by different entities, having different structures. Furthermore, other or different operations or sequences may be performed.

An office worker or other person may seek to learn the status of one or appointments such as for example whether a user has confirmed an appointment or how many appointments have been confirmed for the next day or if any reminders are to be sent to a user regarding a future appointment. Alternatively, appointment manager 112 may be configured to automatically request an update on for example one or more users or one or more time periods. In some embodiments, updates may be sent to appointment manager 112 automatically. Other status updates may also be requested.

In operation 710, appointment manager 112 may send a status request in a signal to for example appointment messenger 122 of server 120. The request may be initiated by for example an office worker or automatically for example at some predetermined point before the scheduled times of one or more appointments.

In some embodiments the status request may include one or more UUIDs associated respectively with one or more appointments or one or more reminders, although the invention is not limited in this respect. Other parameters such as for example an appointment time or a period of time (e.g., a specific hour, date, or week) for the search or query of for example database 124 may be included as well.

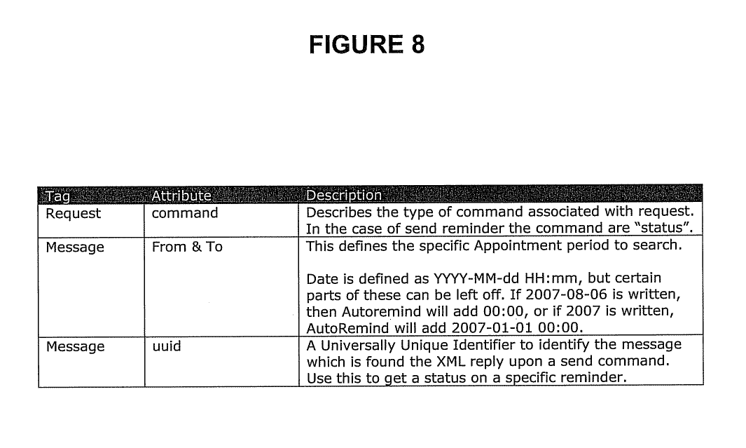

The status request signal may be in format such as that shown in FIG. 8 which is a table of status request formats in accordance with an embodiment of the invention. Although FIG. 8 shows one example format, the invention is not limited in this respect. Other names and formats, the type and number of elements, colors, and other aspects of status request formatting may be used. In the embodiment of FIG. 8, the status requests may be formatted in accordance with for example an XML specification or other format or protocol for transmitting structured data. A command sequence using the format of FIG. 8 may include or be similar to the following:

<request command=″status”>
<message from=″2007-11-10 00:00″ to=″2007-11-10 23:59″>
// Using TO/FROM
</message>
</request>
<request command=″status”>
<message uuid=″6EDA69E4-4C2E-102A-8AFD-F2C70BE044B1″>
// Using UUID
</message>
</request>

In operation 720, the status request signal may be received at appointment messenger 122 of server 120. In some embodiments, appointment messenger 122 may use any UUIDs included in the status request for determining how to process the message and may process the status request according to the UUID(s). To respond, appointment messenger 122 may search or query database 124 for information on appointment status.

Once the information has been collected, appointment messenger 122 may send a status response back to appointment manager 112 or other component of workstation 110 (operation 730). The status response may include, for each appointment in the response, an indicator of the number of reminders to be sent or that have been sent regarding the appointment, the status of any such reminders or other messages (instructions, etc.) to be sent to the user, whether the appointment has been confirmed, and other status indicators relative to the appointment.

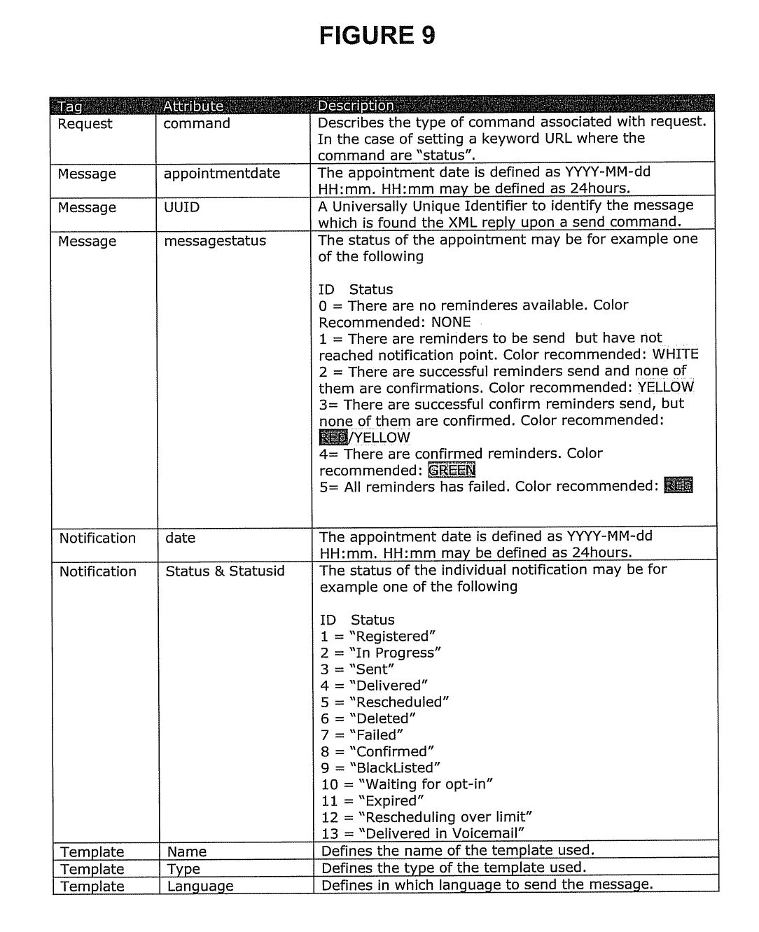

In some embodiments, the format of a status response may be according to FIG. 9, which is a table showing a format for a server to use when responding to a status request in accordance with an embodiment of the invention. Although FIG. 9 shows one example format, the invention is not limited in this respect. Other names and formats, the type and number of elements, colors, and other aspects of response formatting for a server to use when responding to a status request may also be used.

In the embodiment of FIG. 9, the responses may be formatted in accordance with for example an XML specification. If server 120 responds using the format of FIG. 9, the reply may include or be similar to the following:

<reply command=″status>
<message appointmentdate=″2007-08-30 10:00″
uuid=″cee54932-9321-102a-b0ed-8574b633dbb5″
messagestatus=”1”>
<notification address=″12018735220″ date=″2007-08-04 04:40″
status=″delivered″ statusid=”4” template=″personal″
type=”sms” language=”us-en” />
<notification address=″12018735220″ date=″2007-08-04 22:01
status=″sent″ statusid=”3”
template=″personal” type=”e-mail” language=”us-en”/>
</message>
</reply>

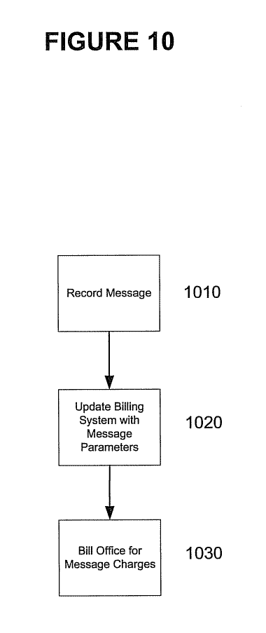

Reference is now made to FIG. 10 which is a flowchart illustration of a method for cost determination in accordance with an embodiment of the invention. While operations are assigned to a server such as server 120 and a message distributor such as message distributor 130 as these entities are described herein, in other embodiments the operations may be performed by different entities, having different structures. Furthermore, other or different operations or sequences may be performed.

In the embodiment of FIG. 10, it is assumed that the initial operations to generate a message to be sent have already been performed. These operations may include for example operations 310-330 or 610-630 and additional or alternative operations. Operation 1010 may proceed in the same manner as for example operation 340 or 640: appointment messenger 122 may send a message to a client device 140. However, in the embodiment of FIG. 10, appointment messenger 122 may send the message using message distributor 130 so as to assure that all messages to client devices 140 being sent by system 100 originate from a single location. Furthermore, as part of operation 1010, certain parameters of sending the message that relate to expenses incurred for sending the message may be recorded. These parameters may include for example signal type such as e-mail, cellular telephone, facsimile, etc.; a measure of the message length such as number bytes, number of seconds of the call, number of pages, an identifier for the organization operating appointment manager 112, for example the name of the doctor's office with which the appointment was made, etc.; and time of day although the invention is not limited in this respect. Other parameters may also be recorded. In some embodiments, these parameters may be recorded at message distributor 130. Alternatively, they may be recorded when generated at appointment messenger 122.

In operation 1020, a billing system such as for example billing system 126 of server 120 may be updated with the recorded message parameters. If the message parameters are recorded at message distributor 130, in some embodiments they may first be sent back to billing system 126 from message distributor 130 prior to being recorded. Billing system 126 may calculate the expenses incurred for sending and receiving messages based on for example the prevailing usage charges for when each message was sent, or other information. In operation 1030, billing system 126 or another component may prepare and send a bill to clients of an appointment messaging service, e.g. an organization operating workstation 110 such as for example a doctor's office with respect to services provided in a manner that directly relates to the actual transmission expenses incurred. In some embodiments, having a single message distributor 130 and a single billing system 126 serving multiple organizations operating multiple appointment managers 112 may facilitate the preparation of complex bills by while reducing transmission costs through the volume of messages sent and reducing the costs of preparing bills with all information available in a single location.

Embodiments of the invention may include an article such as a computer or processor readable medium, or a computer or processor storage medium, such as for example a memory, a disk drive, or a USB flash memory, encoding, including or storing instructions which when executed by a processor or controller, carry out methods disclosed herein.

Although the particular embodiments shown and described herein will prove to be useful for the many appointment messaging systems to which the present invention pertains, further modifications of the present invention will occur to persons skilled in the art. All such modifications are deemed to be within the scope and spirit of the present invention as defined by the appended claims.

What is claimed is:

1. A method comprising:
at a computer, accepting appointment information for a user having an appointment;
sending a first signal, via a network, from the computer to a server remote from the computer, the content of the first signal comprising data related to the appointment information, wherein sending the first signal is triggered by completion of the entering appointment information for the user;
processing the content of the first signal at the server according to the appointment information;
sending, from the server, a message to the user relating to the appointment; and
receiving a response to the message from the user.

2. The method of claim 1, comprising sending a second signal, via the network, from the computer remote from the computer to the server, the content of the second signal comprising a status request of the appointment.

3. The method of claim 1, wherein the message is transmitted via a second signal, the second signal selected from the group consisting of: a cellular telephone call, a text message, a telephone call, and an e-mail message.

4. The method of claim 1, wherein the message comprises instructions to the user relating to the appointment.

5. The method of claim 1, wherein the message comprises instructions for the user to respond to the message.

6. The method of claim 1, comprising, based on the response from the user, sending a confirmation of the appointment to the computer.

7. The method of claim 1, comprising sending, from the server to the computer, a status of the appointment.

8. The method of claim 7, wherein the status of the appointment sent to the computer comprises a confirmation that a reminder message was sent to the user having the appointment.

9. The method of claim 7, wherein the status of the appointment sent to the computer comprises an error signal if the user has not responded to a reminder message from the server to the user.

10. The method of claim 7, comprising sending a second signal, via the network, from the computer to the server, the second signal comprising a status request for the appointment, the status request causing the sending, from the server to the computer, the status of the appointment.

11. The method of claim 1, wherein the first signal and the message are formatted according to an extensible markup language (XML) specification.

12. The method of claim 1, wherein the first signal and the status are sent via hypertext transfer over a secure socket layer (HTTPS) connection.

13. The method of claim 1, comprising sending a plurality of messages to the user relating to the appointment.

14. The method of claim 1, wherein the processing comprises assigning a universal unique identifier (UUID) to the appointment;

15. The method of claim 14, comprising:
sending a second signal, via the network, from the computer to the server, the second signal comprising a status request for the appointment and the UUID of the appointment; and
processing the content of the second signal at the server according to the UUID.

16. A method comprising:
receiving at a server a first signal, via a network, from a computer remote from the server, the first signal comprising information regarding an appointment for a user;
sending, from the server to a client device of the user, a message, the message comprising instructions for responding to the message;
receiving at the server, from the client device, a response to the message; and
sending from the server, via the network, information regarding the response, to the computer.

17. The method of claim 16, wherein the instructions include a request to confirm that the user intends to keep the appointment.

18. The method of claim 16, wherein the message is a text message and the instructions ask the user to respond by pressing a reply button causing a reply text message to be sent

19. The method of claim 16, wherein the information regarding the response is a confirmation of the appointment.

20. The method of claim 16, wherein the information regarding the response is an error signal.

21. The method of claim 20, wherein the error signal is sent if no response to the message from the user is received.

22. The method of claim 16, comprising sending, from the server to a client device of the user, a plurality of messages, the messages each comprising instructions for responding to the respective message.

23. The method of claim 16, comprising receiving at the server a second signal, via the network, from the computer remote from the server, the second signal comprising a status request, the receiving of the second signal causing the sending information regarding the response to the computer.

24. A system comprising:
a memory for storing appointment information; and
a server:
for receiving a first signal sent from a computer remote from the server, via a network, the content of the first signal comprising data related to appointment information for a user having an appointment, the appointment information entered at the computer remote from the server, wherein sending the first signal is triggered by completion of the entering appointment information for the user at the computer for entering appointment information for a user having an appointment;
for processing the content of the first signal according to the appointment information; and
for sending a message to the user relating to the appointment; and for receiving from the user a response to the message.

25. The system of claim 24, wherein the server is configured for receiving a second signal from the computer remote from the server, the content of the second signal comprising a status request of the appointment.

26. The system of claim 25, wherein the server is configured for sending the status of the appointment to the computer remote from the server.

27. The system of claim 25, wherein the server is configured for assigning a universal unique identifier (UUID) to the appointment, the second signal comprising the UUID of the appointment, and for processing the content of the second signal according to the UUID of the appointment.

28. A system comprising:
a memory for storing appointment information; and
a server:
for receiving a first signal sent from a computer remote from the server, via a network, the content of the first signal comprising data related to appointment information for a user having an appointment, the appointment information entered at the computer remote from the server; for sending to a client device of the user a message, the message comprising instructions for responding to the message; for receiving from the client device, a response to the message; and
for sending information regarding the response to the computer remote from the server.

29. The system of claim 28, wherein the instructions include a request to confirm that the user intends to keep the appointment.

30. The system of claim 28, wherein the information regarding the response is a confirmation of the appointment.

31. The system of claim 28, wherein the server is configured to receive a second signal, via the network, from the computer remote from the server, the second signal comprising a status request, the receiving the second signal causing the sending information regarding the response to the computer.
